(19) United States
(12) Patent Application Publication
(10) Pub. No.: US 2022/0161079 A1
(43) Pub. Date: May 26, 2022

(54) CONTROLLABLE AIR MAINTENANCE DEVICES FOR FIRE PROTECTION SYSTEMS

(71) Applicant: Engineered Corrosion Solutions, LLC, St. Louis, MO (US)

(72) Inventor: Adam H. Hilton, Chesterfield, MO (US)

(21) Appl. No.: 17/426,547

(22) PCT Filed: Sep. 20, 2018
(86) PCT No.: PCT/US2018/051896

§ 371 Date: Jul. 28, 2021

Related U.S. Application Data
(60) Provisional application No. 62/562,013, filed on Sep. 22, 2017.

(51) Int. Cl. A62C 35/64; A62C 35/68; G05D 16/20

(52) U.S. Cl. CPC A62C 35/645; G05D 16/2013; A62C 35/68

(57) ABSTRACT

An air maintenance device (AMD) for fire protection system includes a gas inlet configured to couple with a source of compressed gas; a gas outlet configured to couple with a pipe network of the fire protection system; a first sensor configured to sense a system parameter of the pipe network of the fire protection system and to produce a first output corresponding to the system parameter; a first gas flow valve in fluid communication with and between the inlet and the outlet; and a first control circuit in communication with the sensor and with the first gas flow valve. The first gas flow valve is electrically controlled and configured to control a flow of gas from the source of compressed gas into the pipe network. The control circuit is configured to receive the first output from the sensor and output a control signal that is a function of the system parameter to the first gas flow valve. Other example AMDs, systems including AMDs, methods of installing AMDs, and methods of suppling gas to a pipe network using an AMD are also disclosed.

### CROSS REFERENCES

This application claims the priority of, and expressly incorporates by reference the entire disclosure of, United States Provisional Patent Application Ser. No. 62/562,013, filed Sep. 22, 2017.

### TECHNICAL FIELD

The present disclosure relates to air maintenance devices for fire protection systems, and, more particularly, to controllable air maintenance devices for dry pipe and preaction fire protection systems.

### BACKGROUND

This section provides background information related to the present disclosure which is not necessarily prior art.

Fire protection systems include water-based systems (e.g., wet pipe fire protection systems, dry pipe fire protection systems, and preaction fire protection systems), foam based systems, etc. Dry pipe and preaction fire protection systems commonly include an air maintenance device (AMD) having a mechanical pressure regulator to maintain a desired pressure level. Sometimes, the AMD includes a pressure switch that is operated based on system pressure to activate and/or deactivate a source of compressed gas. Industry standards applicable to AMDs include U.L. 260A and FM 1032, the disclosures of each of which are expressly incorporated by reference herein.

### SUMMARY

This section provides a general summary of the disclosure, and is not a comprehensive disclosure of its full scope or all of its features.

According to one aspect of the present disclosure, an air AMD for coupling with a pipe network of a dry pipe or preaction fire protection system is provided that includes a gas inlet configured to couple with a source of compressed gas; a gas outlet configured to couple with a pipe network of the fire protection system; a first sensor configured to sense a system parameter of the pipe network of the fire protection system and to produce a first output corresponding to the system parameter; a gas flow valve in fluid communication with and between the gas inlet and the gas outlet; and a first control circuit in communication with the sensor and with the first gas flow valve. The gas flow valve is electrically controlled and configured to control a flow of gas from the source of compressed gas into the pipe network. The control circuit is configured to receive the first output from the sensor and output a control signal that is a function of the system parameter to the first gas flow valve.

According to another aspect of the present disclosure, a method of installing an AMD in a dry pipe or preaction fire protection system is disclosed. The AMD includes an electrically controlled valve. The method includes installing the AMD in the fire protection system such that the electrically controlled valve is coupled between a source of compressed gas and a pipe network of the fire protection system.

According to yet another aspect of the present disclosure, a method of suppling gas from a source of compressed gas to a pipe network of a dry pipe or preaction fire protection system is disclosed. The fire protection system includes an AMD coupled with the pipe network, and the AMD includes an electrically controlled valve. The method includes sensing a pressure in the pipe network of the fire protection system, and opening the electrically controlled valve of the AMD when the sensed pressure is less than a defined pressure threshold to allow gas from the source of compressed gas to pass into the pipe network.

It is noted that while preaction fire protection systems are sometimes considered to represent a subset of dry pipe fire protection systems, preaction systems are also frequently considered by those in the industry as being distinct from dry pipe systems. The device and method of the present disclosure is suitable for use with dry pipe and preaction fire protection systems. The use of dry pipe or preaction in reference to fire protection systems in this disclosure is not intended to exclude application of the disclosed components, systems, and methods to other fire protection systems. However, some embodiments of the present disclosure may be more suitable to a dry pipe or preaction system, respectively.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of an AMD including an electronically controlled valve according to one example embodiment of the present disclosure.

FIG. 2 is a block diagram of an AMD including the valve of FIG. 1 and a check valve according to another example embodiment.

FIG. 3 is a block diagram of an AMD including one fluid flow path with the valve of FIG. 1 and another fluid flow path with a manually operated valve according to yet another example embodiment.

FIG. 4 is a block diagram of an AMD including two fluid flow paths each including an electronically controlled valve according to another example embodiment.

FIG. 5 is a block diagram of an AMD including a solenoid valve and an auxiliary power source for providing backup power according to yet another example embodiment.

FIG. 6 is a block diagram of an AMD including batteries for providing backup power according to another example embodiment.

FIG. 7 is a block diagram of a dry pipe fire protection system including multiple AMDs according to yet another example embodiment.

FIG. 8 is a block diagram of a preaction fire protection system including multiple AMDs according to another example embodiment.

FIG. 9 is a flow chart of a method of installing an AMD including an electronically controlled valve according to yet another example embodiment of the present disclosure.

Corresponding reference numerals indicate corresponding parts and/or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be noted that AMDs are generally subject to the requirements and guidelines of the standards presented in U.L. 260A and FM 1032, the disclosures of which are hereby incorporated by reference herein and portions of which may be expressly referenced in the present disclosure. While embodiments of the systems and methods of the present disclosure may meet the requirements and guidelines of these standards, the present disclosure is not limited to fire protection systems that are compliant with these standards.

As recognized by the inventors of the subject application, conventional AMDs may be adversely affected by various conditions. For example, conventional AMDs having a mechanical pressure regulator may be adversely affected by the ambient temperature which may affect a set point of the pressure regulator, an upstream pressure which may affect the flow rate through the pressure regulator and/or a maximum pressure setting of the pressure regulator, a pressure differential which may affect the flow rate through the pressure regulator, and corrosion and/or other debris which may affect the functionality of the pressure regulator and/or a backflow prevention device. Additionally, the pressure regulator of conventional AMDs may experience device fatigue causing possible pressure setting failure due to multiple cycles of use. Also, pressure settings in the pressure regulator of conventional AMDs may be difficult to reproduce. Further, when multiple systems are employed, accuracy and precision of their pressure regulator may be affected when coordinating pressure settings between the systems including, for example, when the pressure settings are designed for dry pipe systems or preaction systems.

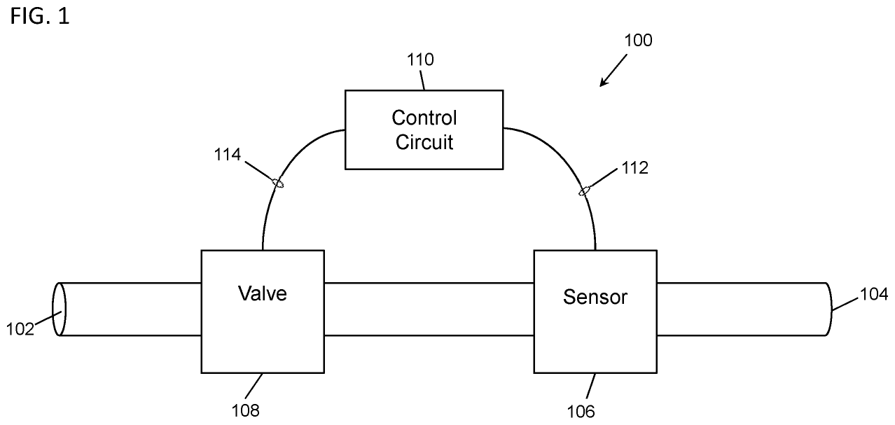

As further explained below, the AMDs disclosed herein each include at least one electrically or electronically controlled gas flow valve that may be used to, among other things, regulate a pressure level in a dry pipe or preaction fire protection system. For example, an AMD for coupling to a pipe network of a dry pipe or preaction fire protection system according to one example embodiment of the present disclosure is illustrated in FIG. 1 and indicated generally by reference number 100. As shown in FIG. 1, the AMD 100 includes an inlet 102 for coupling to a source of compressed gas (not shown), an outlet 104 for coupling to a pipe network (not shown) of a fire protection system, a sensor 106 for sensing pressure in the fire protection system (and/or one or more other system parameters or environmental parameters), an electrically or electronically controlled gas flow valve 108 coupled between the inlet 102 and the outlet 104 and a control circuit 110 coupled to the sensor 106 and the gas flow valve 108. As further explained below, the gas flow valve 108 allows gas from the source of compressed gas to pass into the pipe network. As shown in FIG. 1, the control circuit 110 receives one or more sensor output signals (represented by line 112) from the sensor 106 indicative of the currently sensed pressure within the pipe network and outputs one or more control signals (represented by line 114) to the gas flow valve 108 to open the valve when the sensed pressure is less than a defined pressure threshold to allow gas from the source of compressed gas to pass into the pipe network.

As explained herein, the electrically or electronically controlled gas flow valve 108 may be used to regulate the pressure level in the dry pipe or preaction fire protection system. In the case of a preaction fire protection system, loss of pressure in the pipe network of the system may not, by itself, result in valve actuation. However, it is still necessary for proper system operation for an appropriate pressure to be maintained within the pipe network of a preaction system. For example, in the specific case of a dry pipe fire protection system, the valve 108 may ensure the amount of pressure in the pipe network is greater than a supervisory pressure to prevent the system from unintentionally actuating. In other words, the pressure level may be regulated to prevent unintentional actuation of a dry pipe valve, a preaction valve, etc. in the system. For example, if the sensed pressure from the sensor 106 is less (e.g., falls below, is below, etc.) the defined pressure threshold, the gas flow valve 108 may be controlled to open thereby allowing compressed gas to enter the pipe network. This defined pressure threshold of the valve 108 may be a pressure value above a supervisory pressure that may otherwise actuate (and/or contribute to actuating) the system. The defined pressure threshold of the valve 108 may be, for example, 27 psig, 30 psig, 35 psig, 40 psig, 45 psig, 50 psig, 55 psig, or another suitable value. For example, the standard set forth in FM 1032 recommends maintenance of air pressure within a system in the range of 15-75 psig. Further, it may be possible to operate fire protection systems with supervisory pressures as low as 10-12 psig. It is contemplated that the systems and methods of the present disclosure may be suitable for use across this entire range of system supervisory pressures. In addition, valve 108 may be provided with a defined pressure threshold of that is lower or higher than the supervisory pressures expressly listed above.

In some embodiments, the AMD 100 may regulate the amount of pressure in the dry pipe or preaction fire protection system by opening and closing the gas flow valve 108. In such instances, the AMD 100 (and any one of the other AMDs disclosed herein) may be considered an automatic AMD that discretely opens and closes its gas flow valve.

More particularly, the control circuit 110 for the AMD 100 may respond to one or more system states or input signals from different exterior sensors or other devices that are indicative of actuation of the dry pipe or preaction fire protection system. These may include a rapid pressure drop in the pipe network of the fire protection system, as measured by sensor 106 or other pressure sensors in communication with the pipe network. In a preaction fire protection system, or any other fire protection system that may be in part electrically or electronically communicating with a fire, smoke, and/or heat detection system, the control circuit 110 may be responsive to one or more signals generated by the fire, smoke, and/or heat detection system. In general, it is contemplated within the scope of the present disclosure that the control circuit 110 for the AMD 100 (and any of those AMDs disclosed herein) may be electrically or electronically connected with one or more sensors or other status monitoring devices associated with the fire protection system, the pipe network of the system or other parts thereof, or the environment within which the fire protection system is utilized. It is also contemplated that the control circuit 110 may be in communication with more than one such device. The control circuits disclosed herein may include any suitable control circuit including, for example, a programmable controller. For example, the control circuit may include a digital controller programmed to implement one of more algorithms.

In response to any of these signals, or a combination of signals in the event that the control circuit 110 is in communication with multiple devices, the gas flow valve 108 may be closed to prevent gas from the compressed gas source from entering the pipe network and/or fluid (water, air, gas including compressed gas, etc.) from reaching the compressed gas source. This may, for example, ensure the amount of pressure in the system is less than a high pressure limit. In some examples, if the pipe network is over pressurized (e.g., above a high pressure limit), the amount of time it takes for compressed gas to exit the pipe network via one or more sprinklers and for water to reach those sprinklers (e.g., the most remote sprinklers) may be increased to an unsatisfactory level. Thus, the AMD 100 may regulate the pressure level in the system to also prevent over pressurization, which may otherwise adversely affect the functionality of the fire protection system.

In some embodiments, the valve 108 may be closed if a sensed pressure from the sensor 106 is greater than a defined pressure threshold. In such examples, the control circuit 110 may output the control signals 114 to the gas flow valve 108 to close the valve when the sensed pressure is greater than this defined pressure threshold. Thus, the control circuit 110 may output a signal to the gas flow valve 108 to open the valve to allow compressed gas to enter the pipe network (as explained above), and then output another signal to the gas flow valve 108 to close the valve.

The defined pressure threshold for closing the valve 108 may be the same or greater than the defined pressure threshold for opening the valve 108. In some specific embodiments, the defined pressure threshold for closing the valve 108 is greater than the defined pressure threshold for opening the valve 108. The defined pressure threshold for closing the valve 108 may be, for example, 27 psig, 30 psig, 35 psig, 40 psig, 45 psig, 50 psig, 55 psig, or another suitable value. For example, the standard set forth in FM 1032 recommends maintenance of air pressure within a system in the range of 15-75 psig. Further, it may be possible to operate fire protection systems with supervisory pressures as low as 10-12 psig. It is contemplated that the systems and methods of the present disclosure may be suitable for use across this entire range of system supervisory pressures. In addition, valve 108 may be provided with a defined pressure threshold of that is lower or higher than the supervisory pressures expressly listed above. In some embodiments, one or both defined pressure thresholds for opening and/or closing the valve 108 may be stored in a memory in the control circuit 110.

The defined pressure thresholds may be variable or fixed. For example, one or both defined pressure thresholds may be set and then subsequently adjusted based on, for example, desired results, atmospheric conditions, including, for example, temperature and humidity, in the surrounding environment, system parameters, etc. To facilitate such adjustments, one or more thermometers, hygrometers or other environmental sensors, may be incorporated into the system either locally or remotely. In such examples, the control circuit 110 may be programmed to set one of the defined pressure threshold at an initial value and then reprogrammed to set that defined pressure threshold at another value. In other examples, one defined pressure threshold may be fixed, and the other defined pressure threshold may be adjustable.

Additionally and/or alternatively, the gas flow valve 108 may be closed based on one or more other parameters. For example, the control circuit 110 may output control signal(s) to close the valve after a defined period of time has elapsed. In some examples, the output control signal(s) may be provided based on the elapsed period of time and/or the sensed pressure (as explained above). For example, the control circuit 110 may begin counting an elapsed time after the defined pressure threshold parameter is met.

In the specific example of FIG. 1, the gas flow valve 108 is normally closed. As such, during normal operation (e.g., a steady state) of the fire protection system, gas from the compressed gas source cannot enter the pipe network and fluid cannot reach the compressed gas source via the valve 108. In other embodiments, the gas flow valve 108 may be normally open in its steady state. In such examples, one or more other devices may be used to isolate the compressed gas source from the pipe network, if desired.

As shown in FIG. 1, the sensor 106 is positioned on an output side (e.g., the downstream side, the outlet side, etc.) of the gas flow valve 108. Specifically, and as shown in FIG. 1, the input of the sensor 106 may be coupled to the output of the gas flow valve 108. This ensures the sensor 106 is in fluid communication with the pipe network thereby allowing the sensor 106 to monitor, sense, measure, etc. the pressure within the pipe network of the system coupled to the AMD 100. In other embodiments, the sensor 106 may be positioned on an output side of the outlet 104.

The sensor 106 may be a mechanical device that converts the applied pressure into an electrical signal proportional to that pressure (e.g., a pressure transducer) and/or another suitable pressure sensing device. For example, the sensor 106 may convert the sensed pressure into an analog electrical signal which is then provided to the control circuit 110. The gas flow valve 108 may then be controlled based on this analog electrical signal (and/or a digital signal based on this analog signal) and the defined pressure threshold stored in the control circuit 110. Alternatively, the sensor 106 may provide a digital signal (e.g., a high signal, etc.) after the sensed pressure has fallen below the defined pressure threshold. In such cases, a user may set the defined pressure threshold with the sensor 106. For the purposes of this disclosure, the use of the term or phrase “electrical”, “electrical connection”, or “electrical communication” is deemed to encompass use of an analog electrical signal and/or a digital signal as both are contemplated within the scope of the present disclosure.

The pressure sensing device 106 may include a pressure transducer that senses gas pressure in the pipe network. If the pipe network includes multiple zones and the gas source is supplying gas to only one of the zones, the pressure transducer may sense a gas pressure in only that zone.

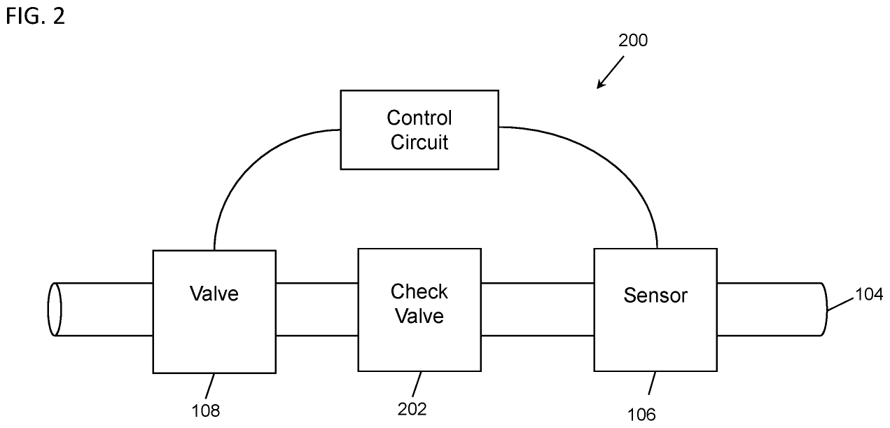

In some embodiments, a back flow restrictor may be used to prevent fluid from flowing from the pipe network of the fire protection system to the gas flow valve 108. For example, FIG. 2 illustrates another AMD 200 substantially similar to the AMD 100 of FIG. 1, but including a back flow restrictor 202 coupled between the gas flow valve 108 and the outlet 104. More specifically, and as shown in FIG. 2, the back flow restrictor 202 is coupled between the gas flow valve 108 and the sensor 106. In such examples, the back flow restrictor 202 may be coupled with the output side of the gas flow valve 108 and the input side of the sensor 106.

In the particular example of FIG. 2, the back flow restrictor 202 includes a check valve which restricts fluid from flowing from the pipe network to the compressed gas source if, for example, the gas source fails, the gas flow valve 108 fails, etc. As such, the check valve 202 may prevent water from entering the gas source if a dry pipe or preaction valve is opened. Although the back flow restrictor 202 of FIG. 2 is shown as a check valve, it should be apparent that other suitable back flow restrictors may be employed without departing from the scope of the disclosure.

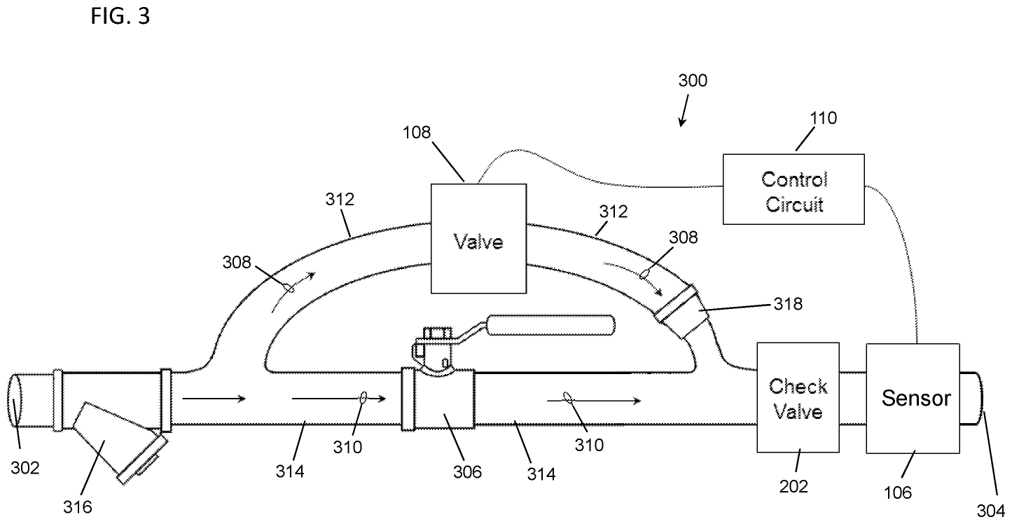

FIG. 3 illustrates another example AMD 300 including the gas flow valve 108, the sensor 106, and the control circuit 110 of FIG. 1, the back flow restrictor 202 of FIG. 2, and a second gas flow valve 306. As shown, the gas flow valves 108, 306, the sensor 106 and the back flow restrictor 202 are coupled between an inlet 302 and an outlet 304 of the AMD 300. Specifically, the valve 306 may be coupled with an input side (e.g., the upstream side, an inlet side, etc.) of the back flow restrictor 202. Similar to the inlet 102 and the outlet 104 of FIG. 1, the inlet 302 may couple with a source of compressed gas, and the outlet 304 may couple with a pipe network of a fire protection system.

As shown in FIG. 3, the AMD 300 includes two fluid flow paths between the inlet 302 and the outlet 304. One fluid flow path is represented by arrows 308 and includes the gas flow valve 108, and the other fluid flow path is represented by arrows 310 and includes the valve 306. As shown, the fluid flow path 308 is defined by one or more pipes 312 and the fluid flow path 310 is defined by one or more pipes 314. As such, compressed gas from the gas source may pass through one or both fluid flow paths 308, 310 via pipes 312, 314 and gas flow valves 108, 306, respectively, depending on the state of the valves.

The fluid flow path 310 may be used for various purposes. For example, the fluid flow path 310 may be used as a bypass to the fluid flow path 308 when the gas flow valve 108 is closed. In such cases, a user may open the valve 306 to allow compressed gas to exit the AMD 300 and flow into the pipe network via valve 306, the back flow restrictor 202, and the sensor 106. This may effectively pressurize the pipe network to a suitable level quicker than, for example, using the fluid flow path 308.

In the particular embodiment of FIG. 3, the valve 306 is a manually operated valve. Specifically, and as shown in FIG. 3, the valve 306 is a ball valve that is normally closed. As such, during normal operation of the dry pipe fire protection system, gas from the compressed gas source cannot enter the pipe network and fluid cannot reach the gas source via the ball valve 306. In other embodiments, the valve 306 may be another suitable valve such as another manually operated valve, an electrically or electronically controlled valve, etc., and may be normally open in its steady state if desired.

The AMD 300 of FIG. 3, and/or any one of the other AMDs disclosed herein, may include one or more optional components such as a “Y” strainer, a flow meter, a restricting orifice, etc. Note that while the present disclosure does not require such components, UL 206A Section 5.3, 5.4, and 5.5 and FM1032 Section 111(C) require one or more of these components. For example, and as shown in FIG. 3, the AMD 300 includes a “Y” strainer 316 and an orifice 318. The “Y” strainer 316 may be coupled between the inlet 302 and the outlet 304. In the particular example of FIG. 3, the “Y” strainer 316 is coupled between the inlet 302 and the fluid flow paths 308, 310. In other words, the “Y” strainer 316 of FIG. 3 may be coupled to the inlet 302 and on the input side (e.g., the upstream side) of the fluid flow paths 308, 310. In some examples, the “Y” strainer 316 includes a perforated mesh screen (e.g., a wire mesh screen) to strain unwanted solids from fluid passing by the strainer 316. In other examples, other suitable strainers may be employed if desired.

The orifice 318 is positioned in the fluid flow path 308. In the particular example of FIG. 3, the orifice 318 is coupled on the output side (e.g., downstream side) of the gas flow valve 108, and between the valve 108 and the back flow restrictor 202. The orifice 318 may restrict a flow of compressed gas through the fluid flow path 308 when the valve 108 is open. The orifice 318 may include a fixed opening, or an adjustable opening allowing a user to alter the size of the opening thereby changing the gas flow rate through the orifice 318.

During normal operating conditions (e.g., after the pipe network is initially pressurized to a suitable level, etc.) of the AMD 300, each of the gas flow valves 108, 306 is closed. Therefore, compressed gas from the compressed gas source is prevented from entering the system. However, once the pressure in the pipe network drops below a defined pressure threshold, the control circuit 110 outputs control signals for opening the gas flow valve 108 (as explained above). During this time, the valve 306 may be closed. This allows compressed gas from the gas source to exit the AMD 300 and flow into the pipe network via the inlet 302, the “Y” strainer 316 (if employed), the valve 108, the orifice 318 (if employed), the back flow restrictor 202, and the sensor 106. Once the pressure in the pipe network increases to another defined pressure threshold, the control circuit 110 outputs control signals for closing the valve 108 (as explained above).

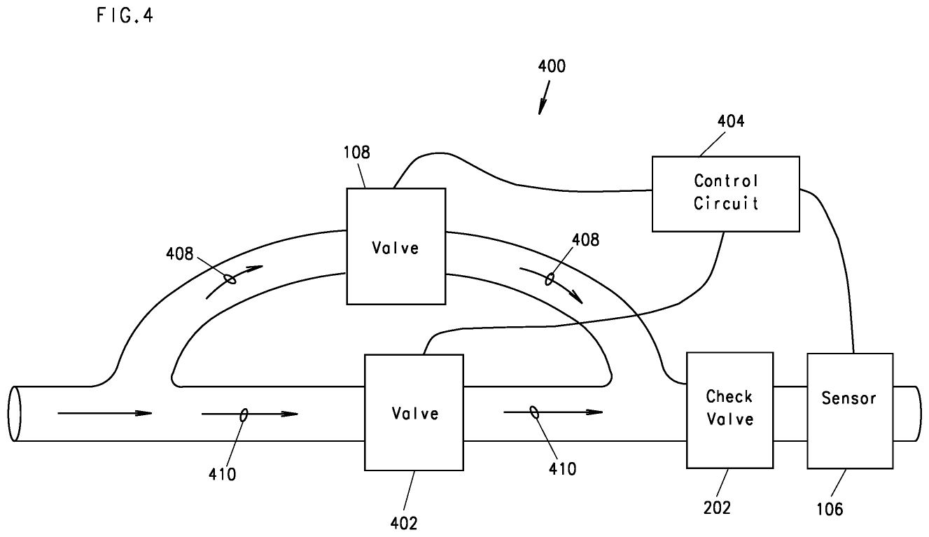

FIG. 4 illustrates another example AMD 400 including the gas flow valve 108 of FIG. 1 in a fluid flow path 408, a second gas flow valve 402 in a fluid flow path 410, and a control circuit 404 coupled to the valves 108, 402. The fluid flow paths 408, 410 are substantially similar to the fluid flow paths 308, 310.

Similar to the control circuits of FIGS. 1-3, the control circuit 404 of FIG. 4 receives input signal(s) from the sensor 106 and outputs control signal(s) to the gas flow valve 108 to open and close the valve depending on the sensed pressure and/or another parameter as explained herein. As such, the AMD 400 may operate in a similar manner as the AMDs of FIGS. 1-3.

Additionally, the control circuit 404 of FIG. 4 may output control signal(s) to the valve 402 for control purposes. In some embodiments, the valve 402 may be controlled based on one or more user inputs. For example, a user may use the control circuit 404 to set a countdown timer to open and/or close the gas flow valve 402. In some examples, once the countdown timer has reached a defined period of time, the control circuit 404 may output a signal to the gas flow valve 402 to close the valve 402. This may, for example, ensure the AMD 400 is not operated in a bypass mode for an undetermined period of time, an undesirably period of time, etc. as may occur if a manually operated valve (e.g., the valve 306 of FIG. 3) is employed.

In some embodiments, the valve 402 may negate the need for an orifice and/or a pressure regulating device typically employed by conventional AMDs.

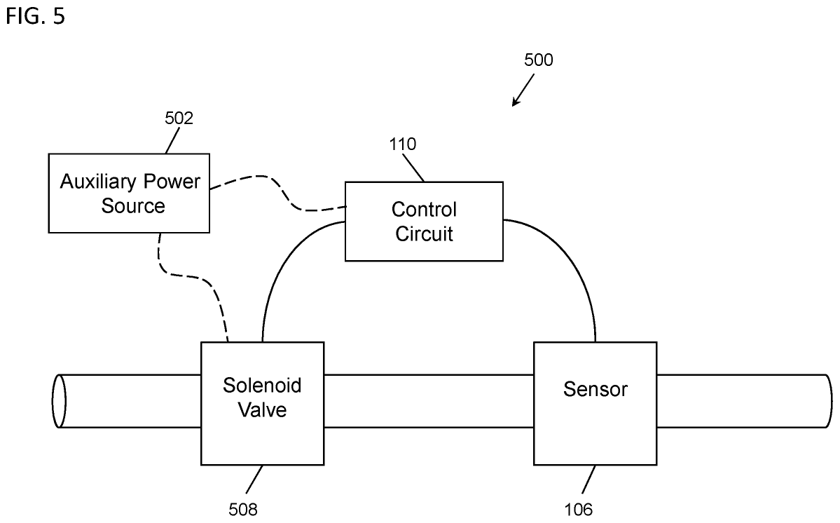

In some examples, the AMDs disclosed herein may include components such as one or more control circuits, valves, etc. that require electrical power. In such examples, a power source is used to power these components, and an optional auxiliary power source may be used to provide backup power. For example, FIG. 5 illustrates an AMD 500 including the control circuit 110 and the sensor 106 of FIG. 1, and a gas flow valve 508 coupled to the control circuit 110.

As shown in FIG. 5, the AMD 500 includes an auxiliary power source 502 coupled to the valve 508 and the control circuit 110. The auxiliary power source 502 provides power to the gas flow valve 508 and/or the control circuit 110 when a primary power source (not shown) is unable to do so. For example, if the primary power source (e.g., a primary battery, mains, etc.) is unable to provide adequate power to the AMD 500, the auxiliary power source 502 may provide backup power for a period of time.

Additionally and/or alternatively, the auxiliary power source 502 may be coupled to other components of the AMD 500 that require electrical power. For example, the power source 502 may be coupled to the sensor 106 if desired.

In the particular example of FIG. 5, the valve 508 includes a solenoid valve which may be controlled similarly to other electrically or electronically controlled valves disclosed herein. The solenoid valve 508 may be controlled by electric current from, for example, a power source such as a primary power source, the auxiliary power source 502, etc. In other embodiments, another suitable electrically or electronically controlled valve including, for example, another electromechanically operated valve may be employed if desired.

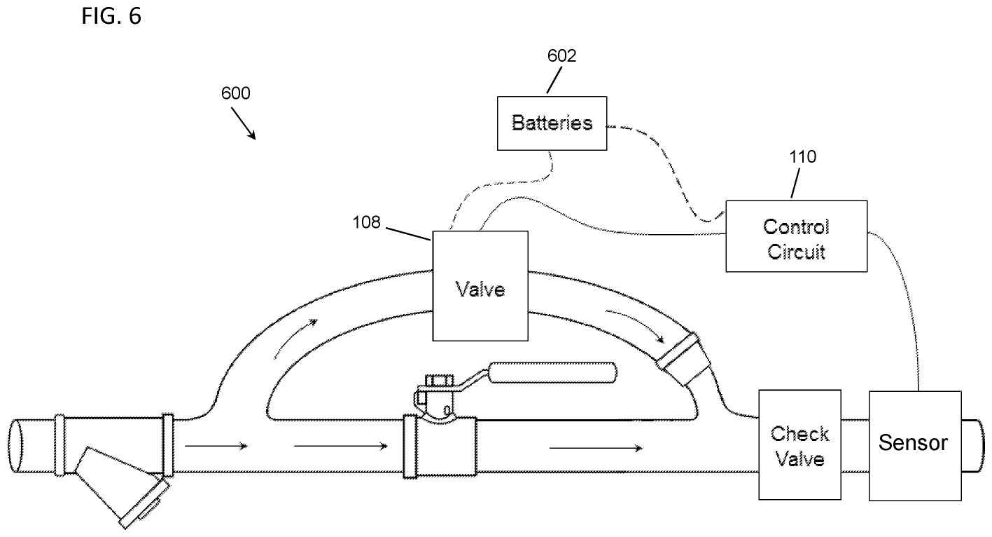

The auxiliary power sources disclosed herein may include one or more batteries and/or another suitable backup power source. For example, FIG. 6 illustrates an

AMD 600 substantially similar to the AMD 300 of FIG. 3, but including one or more batteries 602 coupled to the valve 108 and/or the control circuit 110 as explained above. In some embodiments, the batteries 602 may include one or more rechargeable batteries. In such examples, the batteries 602 may be coupled to the primary power source and/or another charging device to ensure the batteries 602 are adequately charged.

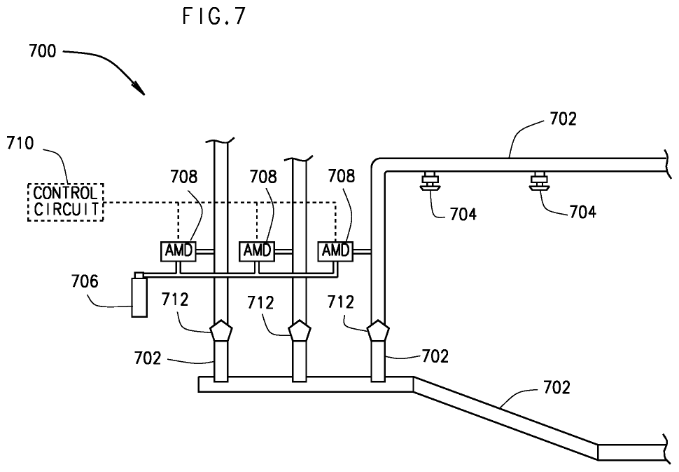

The AMDs disclosed herein may be employed in various water-based fire sprinkler systems including, for example, dry pipe fire sprinkler systems or preaction sprinkler systems, etc. For example, FIG. 7 illustrates an exemplary dry pipe fire protection system 700 including a pipe network 702, one or more sprinklers 704 coupled to the pipe network 702, a source of compressed gas 706, dry pipe valves 712 coupling a source of pressurized water (not shown) to the pipe network 702, and multiple AMDs 708 coupled between the pipe network 702 and the source of compressed gas 706 on the dry side of each dry pipe valve 712. An AMD 708 is supplied for each dry pipe valve 712.

The AMDs 708 may include one or more of the AMDs disclosed herein, components and/or features of one or more of the AMDs, etc. For example, the AMDs 708 may include the AMD 100 having the gas flow valve 108, the sensor 106, and the control circuit 110.

In some embodiments, the AMDs 708 may not include a control circuit. For example, the system 700 may include a control circuit 710 (shown in phantom lines) or the like to control various components and/or features of the system 700 including one or more gas flow valves of the AMDs 708. A single control circuit 710 may provide coordinated control of multiple AMDs 708, or each AMD 708 may be provided with its own control circuit 710. In such examples, the system control circuit 710 may receive signals from a sensor and output control signals to electrically or electronically controlled valve(s), as explained herein.

In other embodiments, the AMDs 708 may include at least a part of a control circuit in communication with a system control circuit that is remote from the AMDs 708. In such examples, the control circuit(s) of the AMDs 708 may send an alarm signal indicating low pressure, loss of power, etc. to the system control circuit

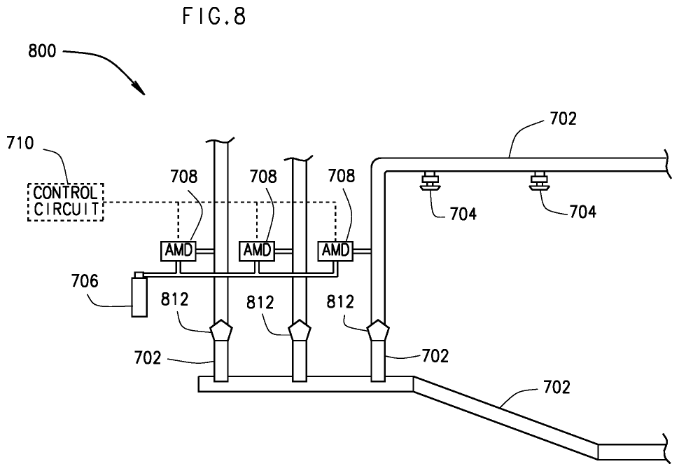

FIG. 8 illustrates a preaction fire protection system 800 that is similar to the dry pipe fire protection system 700 of FIG. 7. For example, the fire protection system 800 includes the pipe network 702, the sprinkler(s) 704, the gas source 706, and the AMDs 708 of FIG. 7. The fire protection system 800 of FIG. 8, however, includes preaction valves 812 for coupling a source of pressurized water (not shown) to the pipe network 702. Thus, in the particular example of FIG. 8, the fire protection system 800 includes a preaction fire protection system.

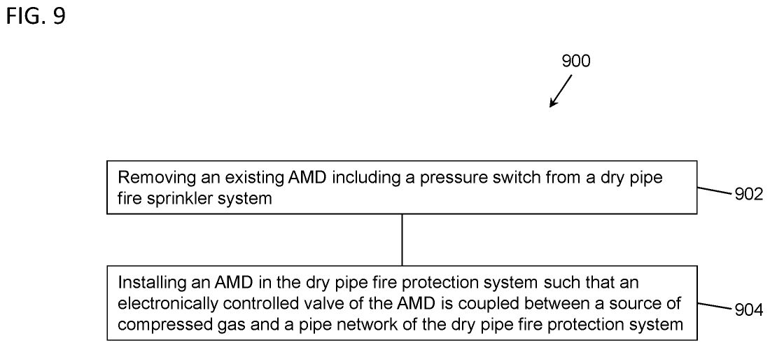

The AMDs disclosed herein may be installed in a new dry pipe, preaction, or deglue fire protection system and/or an existing fire protection system. Additionally, the AMDs may be used in combination with and/or may replace an existing AMD in an existing fire protection. For example, FIG. 9 illustrates a method 900 of installing an AMD in a fire protection system that includes removing an existing AMD of the fire sprinkler system in block 902, and installing the AMD in the fire protection system such that a gas flow valve of the AMD is coupled between a source of compressed gas and a pipe network of the fire protection system in block 904. In some embodiments, and as shown in FIG. 9, the existing AMD that is removed may include a pressure switch or the like for activating and/or deactivating a source of compressed gas.

In other embodiments, the method 900 may not include removing an existing AMD if, for example, the fire protection system is new. In such cases, the method 900 may include the installing step in block 904, but not the removing step in block 902.

The gas flow valves disclosed herein may include a solenoid valve as shown in FIG. 5 and/or another suitable valve. Additionally, the valves may include two-port valves, three-port valves, etc. For example, if a two-port valve is employed, fluid flow may be switched on or off. If a three-port valve is employed, an output of the valve may be switched between two different outlet ports such that fluid entering an input of the valve may flow in one of the two outlet ports.

The sensors disclosed herein may include a gauge pressure sensor that measures pressure relative to atmospheric pressure, a differential pressure sensor, and/or another suitable pressure sensor. In some examples, the pressure sensors may be pressure transducers, as explained above. Additionally, and as explained above, the sensors may provide analog and/or digital outputs, etc.

The control circuits disclosed herein may include an analog control circuit, a digital control circuit (e.g., a digital signal controller (DSC), a digital signal processor (DSP), etc.), or a hybrid control circuit (e.g., a digital control unit and an analog circuit). For example, the digital control circuit may include memory to store one or more of the various thresholds (e.g., the set points) as explained above. The control circuits may be programmed to implement one of more algorithms for opening and/or closing any one of the electrically or electronically controlled gas flow valves disclosed herein based on, for example, one or more parameters, such as system pressure, temperature, humidity, altitude, characteristics of the pipe network, time, etc.

Additionally, the control circuits may include various inputs and outputs. For example, the control circuits each may receive one or more inputs relating to a system pressure, a compressed gas source pressure (e.g., a low source pressure, etc.), a compressed gas source activation, a bypass mode period of time, a bypass mode activation, etc. One or more of the inputs may be user inputs (e.g., the bypass mode period of time, activation of the bypass mode, etc.), sensed inputs, and/or a combination of both. The control circuits each may also provide one or more outputs relating to a loss of power, a pressure level (e.g., a system pressure, a low and/or high system pressure, a pressure loss over a period of time, a compressed gas source pressure, a low and/or high compressed gas source pressure, a pressure upstream and/or downstream of the AMD, etc.), a pressure cycle time, a system refill time, a bypass mode status, a bypass mode timer value, a valve status (e.g., opened, closed, malfunctioning, etc.), a compressed gas source status (e.g., on, off, malfunctioning, etc.), a flow rate through the AMD, an auxiliary power source status (e.g., a battery malfunction, a battery charger malfunction, battery charge level, etc.), etc.

The compressed gas sources disclosed herein may include one or more generators, storage systems such as cylinders, and/or other suitable sources. The compressed gas disclosed herein may include any suitable inert gas such as nitrogen.

By employing one or more of the AMDs disclosed herein, the pressure level of the compressed gas in a pipe network may be regulated at a desired level. This may ensure the dry pipe valve, the preaction valve, etc. in the system is prevented from unintentional actuation due to pressure loss, the system is not over pressurized, etc. as explained above. In some instances, the AMDs may regulate the amount of gas provided to the pipe network to ensure the compressed gas source does not provide more gas to the system than can be released through a single fire sprinkler when opened. If the gas cannot exit through a single actuated sprinkler at a desired rate, a dry pipe valve, a preaction valve, etc. may not open in a desired amount of time or at all. In turn, water may be delayed and/or prevented from entering the pipe network.

Additionally, by employing any one of the AMDs disclosed herein, the compressed gas source coupled to the system may be substantially prevented from short cycling (e.g., turning on/off at an undesirably high rate), a supervisory pressure for a fire protection system may be accurately and reliably set, gases in the pipe network may mix quicker compared to conventional systems due to pressure cycling in the system, various parameters (e.g., pressure, flow, etc.) associated with the AMD and/or the system may be monitored and used as desired, etc. Additionally, the AMDs may include a bypass fluid flow path with a gas flow valve that may provide a supervision and failsafe design.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An air maintenance device for a fire protection system having a pipe network, comprising:
a gas inlet in fluid communication with a source of compressed gas;
a gas outlet in fluid communication with the pipe network;
at least one sensor configured to sense a system parameter within the pipe network and to produce a sensor output signal corresponding to the system parameter of the pipe network;
a first gas flow valve in fluid communication with and between the gas inlet and the gas outlet, the first gas flow valve operable to control a flow of gas from the source of compressed gas into the pipe network, the first gas flow valve being an electrically controlled valve;
a first control circuit in communication with the sensor and with the first gas flow valve, the control circuit configured to receive the sensor output signal, and output at least a first control signal to the first gas flow valve, the first control signal being determined, at least in part, as a function of the system parameter of the pipe network; and
wherein the air maintenance device is exterior to the pipe network.

2. The air maintenance device as set forth in claim 1, further comprising:
the fire protection system being at least one of a dry pipe fire protection system and a preaction fire protection system.

3. The air maintenance device as set forth in claim 2, further comprising:
a flow control valve in fluid communication with a source of a fire suppressive medium, the flow control valve having a flow control valve outlet in fluid communication with the pipe network;
wherein the gas outlet of the first gas flow valve and the sensor are downstream of the flow control valve outlet.

4. The air maintenance device as set forth in claim 1, further comprising: the system parameter of the pipe network including a current system pressure within the pipe network.

5. The air maintenance device as set forth in claim 4, further comprising:
the first control circuit including a rrremory being configured to store a defined pressure threshold in the memory;
the first control circuit being configured to compare the current system pressure within the pipe network with the defined pressure threshold and generate the first control signal as a function of the comparison of the current system pressure within the pipe network with the defined pressure threshold;
the first gas flow valve being configured to open and dose based on the first control signal.

6. The air maintenance device as set forth in claim 5, further comprising: the first gas flow valve configured to open when the current system pressure within the pipe network is lower than the defined pressure threshold and to close when the current system pressure within the pipe network is at least equal to or greater than the defined pressure threshold.

7. The air maintenance device as set forth in claim 1, further comprising:
a back-flow restrictor operable to prevent gas from flowing from the pipe network to the first gas flow valve, the back flow restrictor being in fluid communication with and between the gas inlet and the gas outlet and upstreamof the sensor.

8. The air maintenance device as set forth in claim 1, further comprising:
a first flow path in fluid communication with the gas inlet and the gas outlet, the first gas flow valve being in fluid communication with and controlling a first flow of gas through the first flow path;
a second flow path in fluid communication with the gas inlet and the gas outlet and in parallel with the first flow path; and
a second gas flow valve that is in fluid communication with and controlling a second flow of gas within the second flow path.

9. The air maintenance device of claim 8. further comprising:
the second gas flow valve being a manually operated valve.

10. The air maintenance device of claim 8, further comprising:
the second gas flow valve being an electrically operated valve; and
the second gas flow valve being in communication with the first control circuit.

11. The air maintenance device of claim 1, further comprising:
a flow restricting orifice in fluid communication with and between the gas inlet and the gas outlet.

12. The air maintenance device of claim 1, further comprising:
the first gas flow valve including a solenoid valve.

13. The air maintenance device of claim 1, further comprising:
the source of compressed gas including a nitrogen generator.

14. The air maintenance device of claim 1, further comprising:
at least a second flow control valve a source of a fire suppressive medium, the second flow control valve having a second flow control valve outlet in fluid communication with the pipe network; and
wherein there is at least a second air maintenance device having the same arrangement as the first air maintenance device including a second gas flow valve having a second gas inlet and a second gas outlet, the gas outlet of the first gas flow valve being downstream of the first flow control valve and the second gas outlet of the second gas flow valve being downstream of the second flow control valve.

15. The air maintenance device of claim 14, further comprising:
both the first and second gas flow valves being in communication with the first control circuit and configured to receive the first signal from the first control circuit.

16. The air maintenance device of claim 14, further comprising:
a second control circuit in communication with the sensor and with the second gas flow valve, the second control circuit configured to receive the sensor output signal and output a second control signal to the second gas flow valve, the second control signal being determined, at least in part, as a function of the system parameter.

17. The air maintenance device of claim 1, further comprising:
a control system configured to operate the fire protection system and generate a system status signal; and
the first control circuit being in electrical communication with the control system and configured to receive the system status signal from the control system and wherein the first control signal is, at least in part, a function of the system parameter of the pipe network and the system status signal.

18. The air maintenance device of claim 1, further comprising:
at least one environmental sensor configured to monitor at least one environmental parameter exterior to the pipe network;
the at least one environmental sensor in communication with the first control circuit and configured to generate an environmental status signal; and
the first control circuit being configured to receive the environmental status signal and wherein the first control signal is, at least in part, a function of the system parameter and the at least one environmental parameter.

19. An air maintenance device for at least one of a dry pipe fire protection system and a preaction fire protection system that includes a pipe network and at least a first flow control valve having an outlet and an inlet and being operative to control the flow of a fire suppressive substance into the pipe network, the air maintenance device comprising:
a gas inlet in fluid communication with a compressed gas source;
a gas outlet in fluid communication with the pipe network downstream of the first flow control valve;
a sensor configured to sense a current system pressure within the pipe network and to generate a sensor output signal corresponding to the current system pressure within the pipe network;
an electrically controlled first gas flow valve in fluid communication with and between the gas inlet and the gas outlet, the first gas flow valve operable to control a flow of gas from the compressed gas source;
the sensor and the gas outlet being downstream of the first flow control valve outlet; and
a control circuit in electrical communication with the sensor and the first gas flow valve, the control circuit including a memory configured to store a defined pressure threshold in the memory;
the control circuit being configured to receive the sensor output signal, and generate and output to the first gas flow valve a control signal, the control signal being determined, at least in part, as a function of whether the current system pressure within the pipe network is lower than the defined pressure threshold or equal to or greater than the defined pressure threshold; and
wherein the first gas flow valve, in response to the first control signal, opens when the current system pressure within the pipe network is lower than the defined pressure threshold and closes when the current system pressure within the pipe network is at least equal to or greater than the defined pressure threshold.

20. The air maintenance device of claim 19, further comprising:
the source of compressed gas including a nitrogen generator.

21. The air maintenance device of claim 19, further comprising:
at least a second flow control valve configured to control a flow of the fire suppressive medium into at least a second portion of the pipe network of the fire protection system, the second flow control valve having a second flow control valve outlet in fluid communication with the at least second portion of the pipe network; and
wherein there is at least a second air maintenance device having the same arrangement as the first air maintenance device including a second gas flow valve having a second gas inlet and a second gas outlet, the gas outlet of the first gas flow valve being downstream of the first flow control valve and the second gas outlet being downstream of the second flow control valve outlet.

22. A method ofinstalling an air maintenance device in at least one of a dry pipe fire protection system and a preaction fire protection system that includes a pipe network and at least a first flow control valve having an outlet and an inlet and being operative to control the flow of a fire suppressive medium into the pipe network; comprising the steps of:
providing an air maintenance device that includes:
a gas inlet in fluid communication with a compressed gas source;
a gas outlet in fluid communication with the pipe network;
a sensor configured to sense a system pressure within the pipe network and to generate a sensor output signal corresponding to the system pressure;
an electrically controlled first gas flow valve in fluid communication with and between the gas inlet and the gas outlet, the first gas flow valve operable to control a flow of gas from the compressed gas source;
a control circuit in electrical communication with the sensor and the first gas flow valve, the control circuit including a memory configured to store a defined pressure threshold in the memory and to output a control signal to the first gas flow valve, the control signal being determined, at least in part, as a function of whether the current system pressure within the pipe network is lower than the defined pressure threshold or equal to or greater than the defined pressure threshold, and
wherein the first gas flow valve, in response to the control signal, opens when the current system pressure within the pipe network is lower than the defined pressure threshold and closes when the current system pressure within the pipe network is at least equal to or greater than the defined pressure threshold; and
installing the air maintenance device in the fire protection system such that the first gas flow valve is between the source of compressed gas and the pipe network of the fire protection system and wherein the sensor and the gas outlet of the first gas flow valve are downstream of the first flow control valve outlet.

23. A method of suppling gas from a source of compressed gas to a pipe network of at least one of a dry pipe fire protection system and a preaction fire protection system that includes a pipe network and at least a first flow control valve having an outlet in fluid communication with the pipe network and an inlet in fluid communication with a source of a fire suppressive medium and being operative to control the flow of the fire suppressive medium into the pipe network; comprising the steps of:
providing an air maintenance device that includes:
a gas inlet in fluid communication with a compressed gas source;
a gas outlet in fluid communication with the pipe network downstream of the first flow control;
a sensor in fluid communication with the pipe network;
an electrically controlled first gas flow valve in fluid communication with and between the gas inlet and the gas outlet, the first gas flow valve operable to control a flow of gas from the compressed gas source; and
a control circuit in electrical communication with the sensor and the first gas flow valve, the control circuit including a memory being configured to store a defined pressure threshold in the memory and generate a control signal;
sensing a current system pressure within the pipe network of the fire protection system with the sensor; and
generating a sensor output signal in the sensor based on the current system pressure within the pipe network and transmitting the sensor output signal to the control circuit
comparing, the current system pressure within the pipe network with the defined pressure threshold;
generating the control signal as a function of whether the current system pressure within the pipe network is higher or lower than the defined pressure threshold and transmitting the control signal to the first gas valve; and
opening the first gas valve when the current system pressure within the pipe network is less than the defined threshold to allow gas from the source of compressed gas to pass into the pipe network and closing the first gas valve when the current system pressure within the pipe network is equal to or greater than the defined threshold to prevent gas from the source of compressed gas from passing into the pipe network.
